(19) United States
(12) Patent Application Publication
(10) Pub. No.: US 2010/0179975 A1
(43) Pub. Date: Jul. 15, 2010

(54) METHOD FOR DECOMPOSING BARREL SHIFTER, DECOMPOSED CIRCUIT AND CONTROL METHOD THEREOF

(75) Inventors: Yen Chin Liao, Jhubei City (TW); Chun Hsien Wen, Jhubei City (TW); Cheng Hsuan Wu, Jhubei City (TW); Jiunn Tsair Chen, Jhubei City (TW)

Correspondence Address: HAMRE, SCHUMANN, MUELLER & LARSON, P.C., P.O. BOX 2902, MINNEAPOLIS, MN, 55402-0902, US

(73) Assignee: RALINK TECHNOLOGY CORPORATION, JHUBEI CITY (TW)

(21) Appl. No.: 12/499,680

(22) Filed: Jul. 8, 2009

(30) Foreign Application Priority Data
Jan. 9, 2009 (TW) 098100569

(51) Int. Cl. G06F 7/00

(52) U.S. Cl. 708/209

(57) ABSTRACT

A method for decomposing a barrel shifter decomposes N, the number of digits of input word, into N₁ to Nₘ, and utilizes m layers of shifter circuit layer, which are composed of a plurality of barrel shifters, such that each barrel shifter performs a shifting procedure to obtain the desired output word.

### BACKGROUND OF THE INVENTION

1. Field of the Invention

The present invention relates to a barrel shifter, and more particularly, to a method for decomposing a barrel shifter, a decomposed shifter circuit and a control method thereof.

2. Description of the Related Art

A barrel shifter is a digital circuit that cyclic shifts a multiple-digit input word in a clock cycle, wherein the number of shifted digits is determined by a control signal. For example, a barrel shifter can right-shift an eight-digit input word 00101111 three digits to make 11100101. A barrel shifter is mainly composed of a large quantity of multiplexers, wherein the number of required multiplexers can be estimated as: the required two-input multiplexers=n×log₂(n), wherein n is the number of digits of the input word of the barrel shifter. For example, for a 32-digit barrel shifter, it is composed of 32×log₂(32)=160 two-input multiplexers.

Barrel shifters are mostly applied in floating point computations in digital circuits, or cyclic shift operations in encoding/decoding processes. For example, in a wireless communication device complying with IEEE 802.11n standard, 12 low-density parity check (LDPC) codes are utilized, and if these LDPC codes are implemented by quasi-cyclic LDPC (QC-LDPC) technique, then each LDPC decoding circuit requires a barrel shifter.

However, if the input word is too long (e.g., in a wireless communication device complying with IEEE 802.11n standard, each LDPC decoding circuit requires an 81-digit barrel shifter), the digital circuit synthesized by a synthesis-software program is often too large to meet the requirement. A typical digital circuit synthesis-software program searches for an optimum solution of a circuit to be synthesized based on various algorithms to meet the requirement of area and computation speed. However, for a digital circuit with too many components, a synthesis-software program is less likely to find an optimum solution due to computation complexity, or it may fill in too many unnecessary elements such as buffers to meet the required computation speed. On the other hand, for a digital circuit with fewer components, a synthesis-software program is more likely to find an optimum solution and unnecessary elements are less likely to be filled in.

Therefore, there is a need to design a method for decomposing a barrel shifter, which can decompose a large barrel shifter into several smaller barrel shifters such that when synthesizing, the computation time and circuit area can be significantly reduced.

### SUMMARY OF THE INVENTION

The method for decomposing a barrel shifter, the decomposed shifter circuit and the control method thereof according to the embodiments of the present invention, perform circuit decomposition based on factor decomposition.

The method for decomposing a barrel shifter such that an N-digit barrel shifter is decomposed into a plurality of barrel shifters with fewer digits according to an embodiment of the present invention comprises the steps of: decomposing N as the product of N₁ to Nₘ, wherein N₁ to Nₘ are integers not equal to 1; for k equal to 1 to m, constructing (N/Nₖ) Nₖ-digit barrel shifters to form m layers of shifter circuit layer; and coupling the output terminals of the barrel shifters in the r^{th} layer to the input terminals of the barrel shifters in the (r+1)^{th} layer, wherein r is an integer ranging from 1 to m−1.

The shifter circuit according to an embodiment of the present invention comprises (N/Nₖ) Nₖ-digit barrel shifters in the k^{th} layer, wherein k is an integer ranging from 1 to m, N is the product of N₁ to Nₘ, and N₁ to Nₘ are integers not equal to 1.

The method for controlling the aforementioned shifter circuit to cyclic shift an N-digit input word by S digits according to an embodiment of the present invention comprises the steps of: calculating a vertical shift value S_{V1} and a horizontal shift value S_{H1} in the 1^{st} shifter circuit layer, wherein S_{V1} is floor(S/(N/N₁)), S_{H1} is mod(S,(N/N₁)); calculating vertical shift values S_{Vk} and horizontal shift values S_{Hk} in the q^{th} shifter circuit layer, wherein S_{Vq} is floor(P/(M/I)), S_{Hq} is mod(P, (M/I)), q is an integer ranging from 2 to m−1, P is the horizontal shift value in the (q−1)^{th} shifter circuit layer S_{H(q-1)}, M is

$${\prod }_{u = q}^{m} {N}_{u}$$

and I is N²; grouping the barrel shifters in the q^{th} shifter circuit layer into

$${\prod }_{u = 1}^{q - 1} {N}_{u}$$

groups, wherein q is an integer ranging from 2 to m−1; controlling all of the barrel shifters in the 1^{st} shifter circuit layer to cyclic shift S_{V1} digits; controlling the first S_{Hq} barrel shifters in each group in the q^{th} shifter circuit layer to cyclic shift mod(S_{Vq}+1, I) digits, and the remaining barrel shifters in the q^{th} shifter circuit layer to cyclic shift S_{Vq} digits; and controlling all of the barrel shifters in the m^{th} shifter circuit layer to cyclic shift S_{H(m-1)} digits.

### BRIEF DESCRIPTION OF THE DRAWINGS

The objectives and advantages of the present invention will become apparent upon reading the following description and upon referring to the accompanying drawings of which:

FIG. 1 shows a matrix of a rearranged input word;

FIG. 2 shows a matrix after a vertical cyclic shift;

FIG. 3 shows a matrix after vertical and horizontal cyclic shifts;

FIG. 4 shows a matrix of a rearranged input word;

FIG. 5 shows a matrix after a first vertical cyclic shift;

FIG. 6 shows a matrix of a rearranged input word;

FIG. 7 shows a matrix after a second vertical cyclic shift;

FIG. 8 shows a matrix after a second vertical cyclic shift and a horizontal cyclic shift;

FIG. 9 shows the flow chart of the method for decomposing a barrel shifter according to an embodiment of the present invention;

FIG. 10 shows a decomposed shifter circuit according to an embodiment of the present invention;

FIG. 11 shows a decomposed shifter circuit according to another embodiment of the present invention; and

FIG. 12 shows the flow chart of the control method of a shifter circuit according to an embodiment of the present invention.

### DETAILED DESCRIPTION OF THE INVENTION

The present invention discloses a cyclic shift method that decomposes a single cyclic shift operation into several cyclic shift operations of smaller scale. Based on the cyclic shift method, the method for decomposing a barrel shifter according to the embodiments of the present invention decomposes an N-digit barrel shifter into several barrel shifters with fewer digits, wherein the circuit composed by these barrel shifters can cyclic shift an input word with N digits.

To cyclic shift an N-digit word S digits, the cyclic shift method decomposes N as the product of N₁ to Nₘ, and then cyclic shifts m limes to obtain the result. In the first cyclic shift, a vertical shift value S_{V} and a horizontal shift value S_{H} are calculated, the vertical shift value S_{V} is equal to floor(S/(N,N₁)), the horizontal shift value S_{H} is equal to mod(S,(N/N₁)), mod is modulo operation, and floor is floor operation. The N-digit word is then rearranged as a matrix with N/N₁ columns and N₁ rows, wherein the 1^{st} to S_{H}^{th} columns are vertically shifted by mod(S_{V}^{+1,} N₁) digits, and the remaining columns are vertically shifted by S_{V} digits. If m equals 2, then every row of the matrix is horizontally shifted by S_{H} digits. If m does not equal 2, then every row of the matrix is decomposed according to the cyclic shift method, wherein the new parameter N′ is equal to N,N₁, m′ is equal to m−1, and the words are to be shifted S_{H} digits.

A wireless communication device complying with IEEE 802.11n standard utilizes three LDPC codes, requiring an 81-digit, a 54-digit and a 27-digit cyclic shift operation respectively. Applying the aforementioned cyclic shift method to an 81-digit barrel shifter, if the input word of the 81-digit barrel shifter is to be cyclic shifted 23 digits, then N=81 is decomposed into 9×9, i.e., both N₁ and N₂ are equal to 9, and S_{V}=floor(23/9)=2, S_{H}=mod(23, 9)=5.

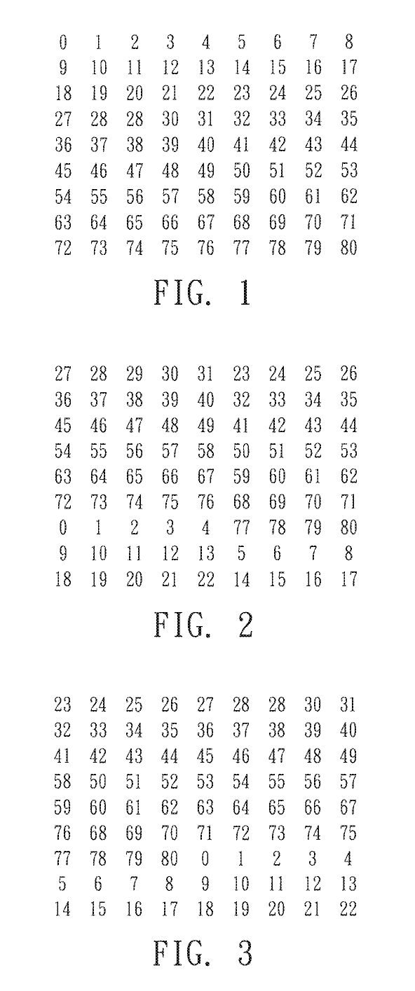

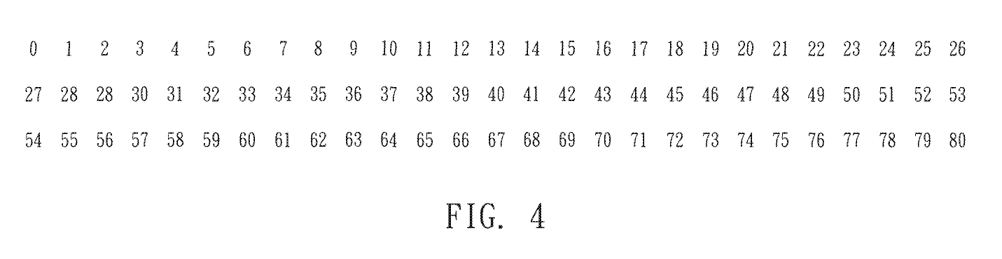

FIG. 1 shows a 9×9 matrix of the rearranged input word. The 1^{st} to 5^{th} columns are vertically shifted by mod(2+1, 9)=3 digits, and the 6^{th} to 9^{th} columns are vertically shifted by 2 digits, as shown in FIG. 2. Since m is equal to 2, all of the rows are horizontally shifted 5 digits, as shown in FIG. 3. The resulted output word is obtained by rearranging the matrix into an 81-digit word.

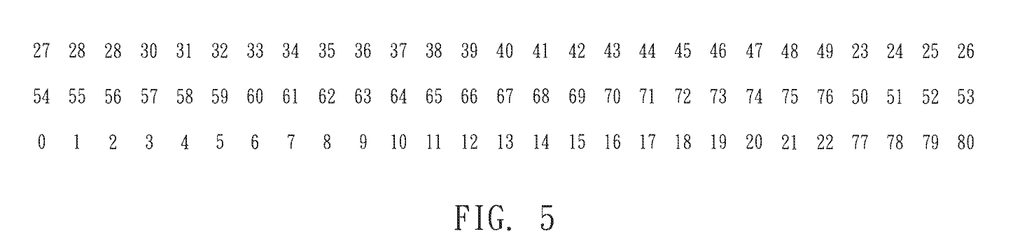

If N=81 is decomposed into 3×3×9, then both N₁ and N₂ are equal to 3 and N₃ is equal to 9, S_{V}=floor(23/27)=0, S_{H}=mod(23, 27)=23. FIG. 4 shows a 3×27 matrix of the rearranged input word. The 1^{st} to 23^{rd} columns are vertically shifted by mod(0+1, 3)=1 digits, and the 24^{th} to 27^{th} columns are vertically shifted by 0 digit, as shown in FIG. 5. Since m does not equal 2, the three decomposed rows continue to be decomposed with shift digit 23 digits.

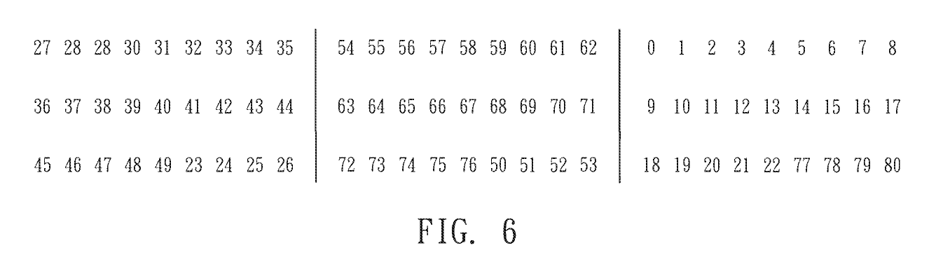

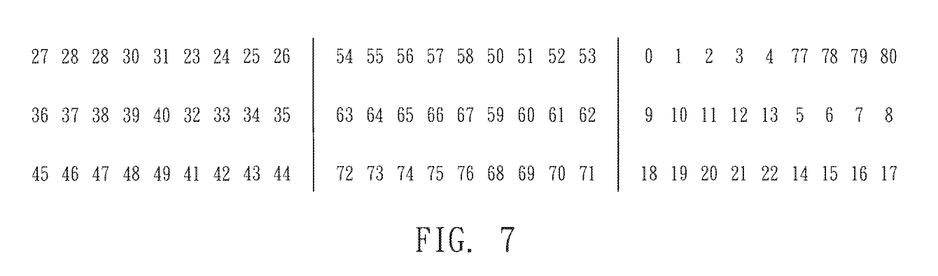

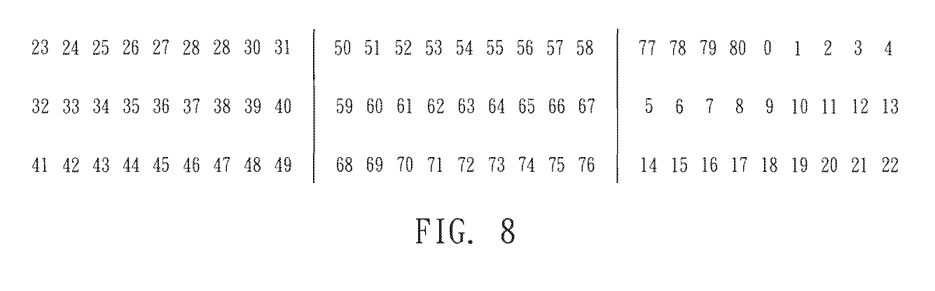

The number of digits of these three rows are all 27, which can be decomposed as 3×9, then S_{V}=floor(23/9)=2 and S_{H}=mod(23, 9)=5. FIG. 6 shows three 3×9 matrixes of these rearranged rows, wherein the left matrix, the middle matrix and the right matrix represent the first row, the second row and the third row respectively. The 1^{st} to 5^{th} columns of each matrix are vertically shifted by mod(2+1, 3)=0 digit, and the 6^{th} to 9^{th} columns of each matrix are vertically shifted by 2 digits, as shown in FIG. 7. Since m is equal to 2, all of the rows are horizontally shifted 5 digits, as shown in FIG. 8. The resulted output word is obtained by rearranging these matrixes into an 81-digit word.

The method for decomposing a barrel shifter according to an embodiment of the present invention is based on the aforementioned cyclic shift method and utilizes a plurality of barrel shifters coupled together to cyclic shift a longer input word.

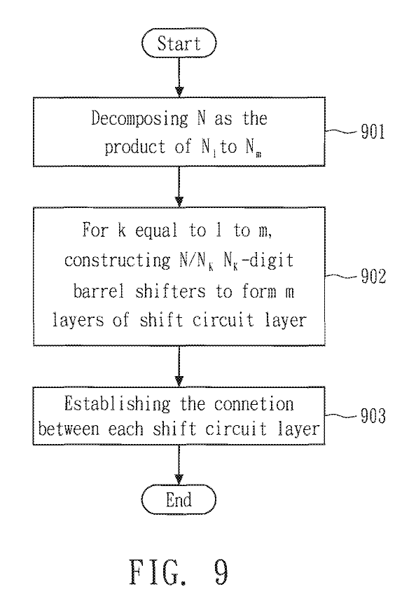

FIG. 9 shows the flow chart of the method for decomposing a barrel shifter according to an embodiment of the present invention, wherein the barrel shifter to be decomposed can cyclic shift an N-digit input word. In step 901, N is decomposed as the product of N₁ to Nₘ, wherein N₁ to Nₘ are integers not equal to 1, and step 902 is executed. In step 902, for k equal to 1 to m, (N/Nₖ) Nₖ-digit barrel shifters are constructed to form m layers of shifter circuit layer, and step 903 is executed. In step 903, the output terminals of the i^{th} barrel shifter in the r^{th} layer are coupled to the b^{th} input terminal of the a^{th} barrel shifter in the (r+1)^{th} layer, wherein r is an integer ranging from to 1 to m−1, a is equal to

$$floor ( \frac{i - 1}{\frac{N}{{\prod }_{u = 1}^{k} {N}_{u}}} ) \frac{N}{{N}_{k + 1} {\prod }_{u = 1}^{k - 1} {N}_{u}} + \frac{N}{{\prod }_{u = 1}^{k + 1} {N}_{u}} j + mod ( ( i - 1 ) , \frac{N}{{\prod }_{u = 1}^{k + 1} {N}_{u}} ) + 1 ,$$

b is equal to

$$ceiling ( \frac{mod ( ( i - 1 ) , \frac{N}{{\prod }_{u = 1}^{k} {N}_{u}} ) + 1}{\frac{N}{{\prod }_{u = 1}^{k + 1} {N}_{u}}} ) ,$$

j is an integer ranging from 0 to N₁−1, mod is modulo operation, floor is floor operation, and ceiling is ceiling operation.

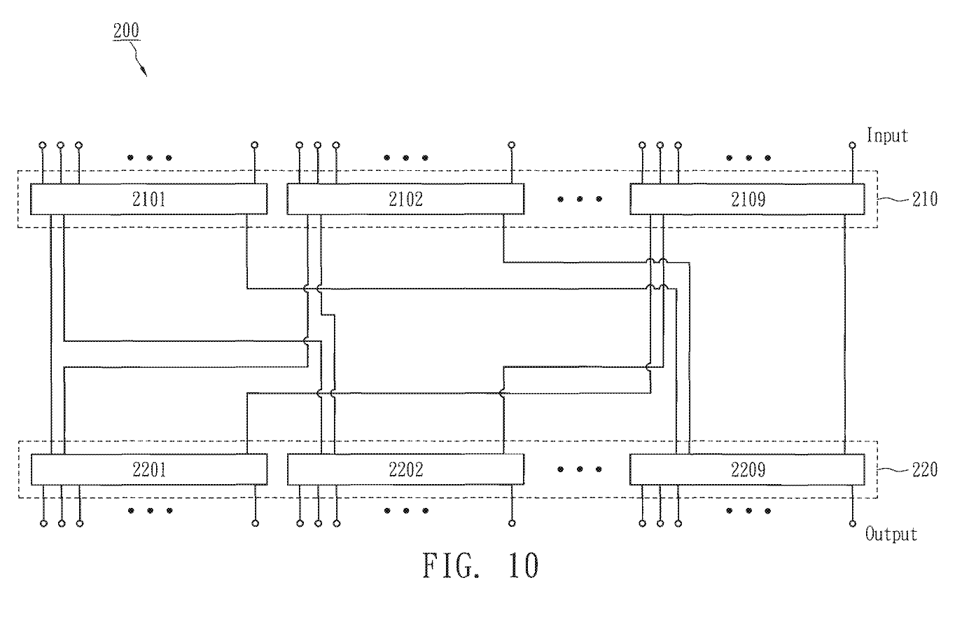

FIG. 10 shows a decomposed shifter circuit 200 obtained by applying the method for decomposing a barrel shifter according to an embodiment of the present invention, wherein the shifter circuit 200 can cyclic shift an 81-digit input word. Following step 901, 81 is decomposed into 9×9, and both N₁ and N₂ are equal to 9. Following step 902, for k equal to 1, 9 9-digit barrel shifters 2101 to 2109 are constructed to form a first shifter circuit layer 210. For k equal to 2, 9 9-digit barrel shifters 2201 to 2209 are constructed to form a second shifter circuit layer 220. Following step 903, the output terminals of the barrel shifters 2101 to 2109 are coupled to the input terminals of the barrel shifters 2201 to 2209.

For the barrel shifter 2101, substitute i=1 into the equations of step 903, and the following results are obtained:

i−1=0;

N/N₁=9; and

N/(N₁×N₂)=1.

The output terminals of the barrel shifter 2101 are coupled to the first input terminals of the (j+1)^{th} barrel shifters in the second shifter circuit layer 220, wherein j is an integer ranging from to 0 to 8. Therefore, the output terminals of the barrel shifter 2101 are coupled to the first input terminals of the barrel shifters 2201 to 2209.

For the barrel shifter 2102, substitute i=2 into the equations of step 903, and the following results are obtained:

i−1=1;

N/N₁=9; and

N/(N₁×N₂)=1.

The output terminals of the barrel shifter 2102 are coupled to the second input terminals of the (j+1)^{th} barrel shifters in the second shifter circuit layer 220, wherein j is an integer ranging from to 0 to 8. Therefore, the output terminals of the barrel shifter 2102 are coupled to the second input terminals of the barrel shifters 2201 to 2209. Calculating for the barrel shifters 2103 to 2109, it can be obtained that the output terminals of these barrel shifters are coupled to the third to the ninth input terminals of the barrel shifters 2201 to 2209. For simplicity, FIG. 10 only shows a part of these barrel shifters and their connections.

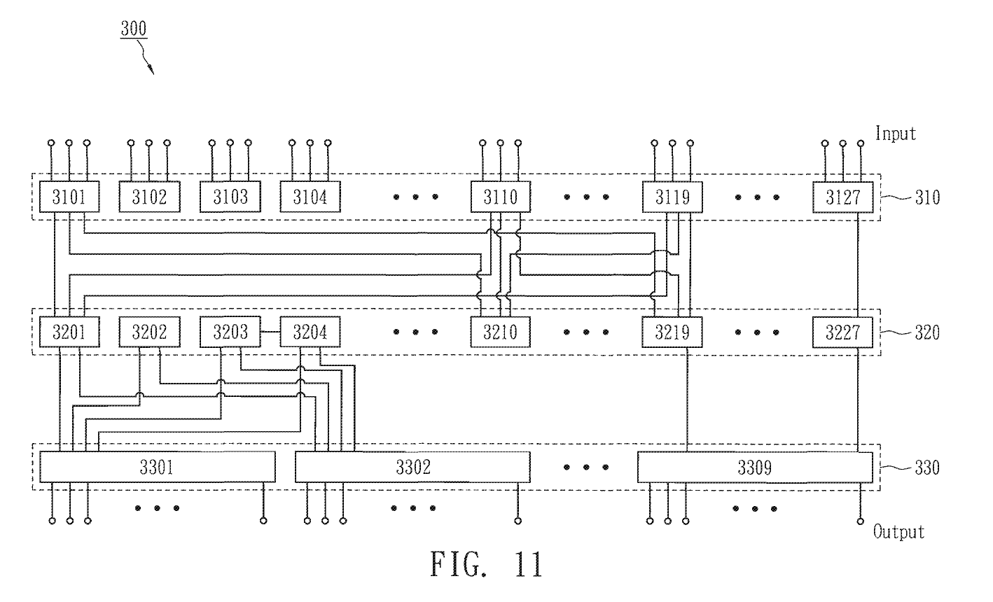

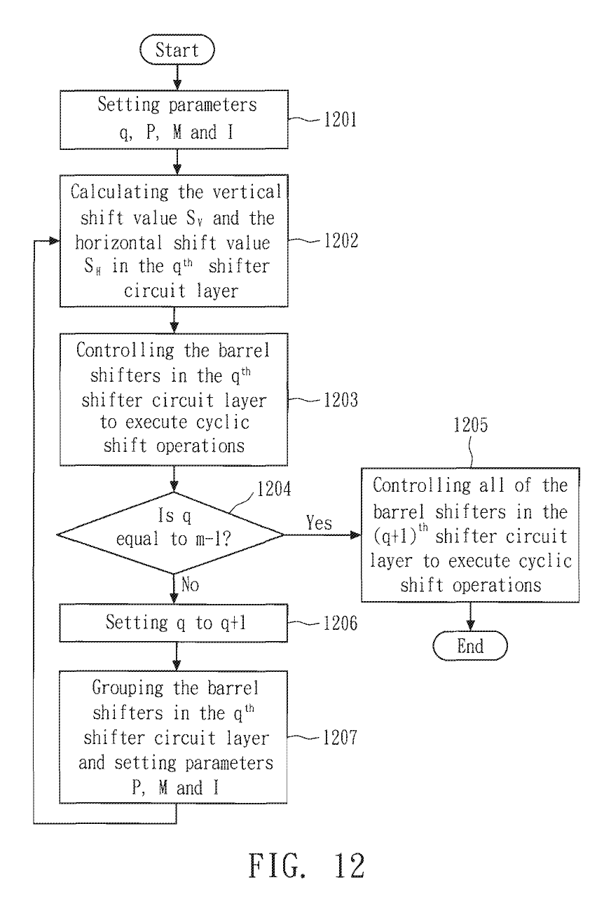

FIG. 11 shows another decomposed shifter circuit 300 obtained by applying the method for decomposing a barrel shifter according to an embodiment of the present invention, wherein the shifter circuit 300 can cyclic shift an 81-digit input word. Following step 901, 81 is decomposed into 3×3×9, wherein both N₁ and N₂ are equal to 3, and N₃ is equal to 9. Following step 902, for k equal to 1, 27 3-digit barrel shifters 3101 to 3127 are constructed to form a first shifter circuit layer 310. For k equal to 2, 27 3-digit barrel shifters 3201 to 3227 are constructed to form a second shifter circuit layer 320. For k equal to 3, 9 9-digit barrel shifters 3301 to 3309 are constructed to form a third shifter circuit layer 330. Following step 903, the output terminals of the barrel shifters 3101 to 3127 are coupled to the input terminals of the barrel shifters 3201 to 3227, and the output terminals of the barrel shifters 3201 to 3227 are coupled to the input terminals of the barrel shifters 3301 to 3309.

For the barrel shifter 3101, substitute i=1 into the equations of step 903, and the following results are obtained:

i−=0;

N/N₁=27;and

N/(N₁×N₂)=9

The output terminals of the barrel shifter 3101 are coupled to the first input terminals of the (9j+1)^{th} barrel shifters in the second shifter circuit layer 320, wherein j is an integer ranging from to 0 to 2. Therefore, the output terminals of the barrel shifter 3101 are coupled to the first input terminals of the barrel shifters 3201, 3210 and 3219.

For the barrel shifter 3102, substitute i=2 into the equations of step 903, and the following results are obtained:

i−1=1;

N/N₁=27; and

N/(N₁×N₂)=9.

The output terminals of the barrel shifter 3102 are coupled to the first input terminals of the (9j+2)^{th} barrel shifters in the second shifter circuit layer 320, wherein j is an integer ranging from to 0 to 2. Therefore, the output terminals of the barrel shifter 3102 are coupled to the first input terminals of the barrel shifters 3202, 3211 and 3220.

For the barrel shifter 3110, substitute i=10 into the equations of step 903, and the following results are obtained:

i−1=9;

N/N₁=27; and

N/(N₁×N₂)=9.

The output terminals of the barrel shifter 3110 are coupled to the second input terminals of the (9j+1)^{th} barrel shifters in the second shifter circuit layer 320, wherein j is an integer ranging from to 0 to 2. Therefore, the output terminals of the barrel shifter 3110 are coupled to the second input terminals of the barrel shifters 3201, 3210 and 3219.

For the barrel shifter 3201, substitute i=1 into the equations of step 903, and the following results are obtained:

i−1=0;

N/N₁=9; and

N/(N₁×N₂)=1.

The output terminals of the barrel shifter 3201 are coupled to the first input terminals of the (j+1)^{th} barrel shifters in the third shifter circuit layer 330, wherein j is an integer ranging from to 0 to 2. Therefore, the output terminals of the barrel shifter 3201 are coupled to the first input terminals of the barrel shifters 3301, 3302 and 3303.

For the barrel shifter 3202, substitute i=2 into the equations of step 903, and the following results are obtained:

i−1=1;

N/N₁=9; and

N/(N₁×N₂)=1.

The output terminals of the barrel shifter 3202 are coupled to the second input terminals of the (j+1)^{th} barrel shifters in the third shifter circuit layer 330, wherein j is an integer ranging from to 0 to 2. Therefore, the output terminals of the barrel shifter 3202 are coupled to the second input terminals of the barrel shifters 3301, 3302 and 3303.

For the barrel shifter 3210, substitute i=10 into the equations of step 903, and the following results are obtained:

−1=9;

N/N₁=9; and

N/(N₁×N₂)=1.

The output terminals of the barrel shifter 3210 are coupled to the first input terminals of the (3+j+1)^{th} barrel shifters in the third shifter circuit layer 330, wherein j is an integer ranging from to 0 to 2. Therefore, the output terminals of the barrel shifter 3210 are coupled to the first input terminals of the barrel shifters 3304, 3305 and 3306. For simplicity, FIG. 11 only shows a part of these barrel shifters and their connections.

The control method of a shifter circuit according to an embodiment of the present invention controls a plurality of barrel shifters to cyclic shift a longer word.

FIG. 12 shows the flow chart of the control method of a shifter circuit according to an embodiment of the present invention such that a shifter circuit is controlled to cyclic shift an N-digit input word by S digits, wherein the shifter circuit is obtained from the method for decomposing a barrel shifter according to an embodiment of the present invention. In step 1201, parameter q is set to 1, P is set to S, M to N, I to N₁, and step 1202 is executed. In step 1202, the vertical shift value S_{V} and the horizontal shift value S_{H} in the q^{th} shifter circuit layer are calculated, wherein S_{V} is floor(P/(M/I)), S_{H} is mod(P, (M/I)), and step 1203 is executed. In step 1203, the first S_{H} barrel shifters in the q^{th} shifter circuit layer are controlled to cyclic shift mod(S_{V}+1, I) digits, the remaining barrel shifters in the q^{th} shifter circuit layer are controlled to cyclic shift S_{V} digits, and step 1204 is executed. In step 1204, it is checked whether q is equal to m−1. If q is equal to m−1, step 1205 is executed; otherwise, step 1206 is executed. In step 1205, all of the barrel shifters in the (q+1)^{th} shifter circuit layer are controlled to cyclic shift S_{H} digits, and the control method is ended. In step 1206, q is set to q+1, and step 1207 is executed. In step 1207, all of the barrel shifters in the q^{th} shifter circuit layer are grouped into

$${\prod }_{u = 1}^{q - 1} {N}_{u}$$

groups, wherein P is set to S_{H}, M is set to

$${\prod }_{u = q}^{m} {N}_{u} ,$$

I is set to N_{q}, and step 1202 is executed.

Referring to FIG. 10, to control the shifter circuit 200 to cyclic shift its input word by 23 digits, the number of digits cyclic-shifted by each barrel shift can be controlled by the aforementioned method.

Following step 1201, q is set to 1, P is set to 23, M is set to 81, I is set to 9, and step 1202 is executed. Following step 1202, the vertical shift value S_{V} of the first shifter circuit layer is calculated as floor(23/(81/3))=0, the horizontal shift value S_{H} of the first shifter circuit layer is calculated as mod(23, (81/3))=23, and step 1203 is executed. Following step 1203, the first 23 barrel shifters in the first shifter circuit layer, i.e. the barrel shifters 3101 to 3123, are controlled to cyclic shift mod(0+1, 3)=1 digit, the remaining barrel shifters in the first shifter circuit layer, i.e. the barrel shifters 3124 to 3127, are controlled to cyclic shift 0 digit, and step 1204 is executed. Following step 1204, 1 is not equal to 3−1, and therefore step 1206 is executed. Following step 1206, q is set to 2, and step 1207 is executed. Following step 1207, the barrel shifters in the second shifter circuit layer are grouped into N₁=3 groups, P is set to 23, M is set to N₂×N₃=27, I is set to N_{2=3,} and step 1202 is executed. Following step 1202, the vertical shift value S_{V} of the second shifter circuit layer is calculated as floor(23/(27/3))=2, the horizontal shift value S_{H} of the second shifter circuit layer is calculated as mod(23, (27/3))=5, and step 1203 is executed. Following step 1203, the first 5 barrel shifters of each group in the second shifter circuit layer, i.e. the barrel shifters 3201 to 3205, 3210 to 3214 and 3219 to 3223, are controlled to cyclic shift mod(2+1, 3)=0 digit, the remaining barrel shifters in the second shifter circuit layer, i.e. the barrel shifters 3206 to 3209, 3215 to 3218 and 3224 to 3227, are controlled to cyclic shift 2 digits, and step 1204 is executed. Following step 1204, 2 is equal to 3−1, and therefore step 1205 is executed. Following step 1205, all of the barrel shifters in the third shifter circuit layer, i.e. the barrel shifters 3301 to 3327, are controlled to cyclic shift 5 digits, and the control method is ended.

In conclusion, the method for decomposing a barrel shifter, the decomposed shifter circuit and the control method thereof according to embodiments of the present invention can realize a single and large barrel shifter with a plurality of smaller large barrels to reduce the total area. On the other hand, if the length of an input word of a shifter circuit according to embodiments of the present invention is shorter than the shifter circuit's length, the cyclic shift operation can be executed by only a part of the shifter circuit, while the other part of the shifter circuit can be dedicated to other operations. For example, a wireless communication device complying with IEEE 802.11n standard utilizes three LDPC codes, requiring an 81-digit, a 54-digit and a 27-digit cyclic shift operation respectively. If these LDPC codes are implemented by conventional barrel shifters, they can only be implemented by 81-digit barrel shifters, wherein an 81-digit cyclic shift operation, a 54-digit cyclic shift operation and a 27-digit cyclic shift operation are executed independently. However, if the shifter circuit 300 according to embodiments of the present invention is utilized, when an input word is 54 digits in length, only the barrel shifters 3101 to 3127, 3201 to 3218 and 3301 to 3306 are required to execute the cyclic shift operation. The barrel shifters 3219 to 3227 and 3307 to 3309 can be dedicated to another 27-digit cyclic shift operation. When input words are 27 digits in length, then the barrel shifters 3201 to 3209 and 3301 to 3303 can be grouped into one group, the barrel shifters 3210 to 3218 and 3304 to 3306 can be grouped into another group, and the barrel shifters 3219 to 3227 and 3307 to 3309 can be grouped into yet another group such that the cyclic shift operations of three input words of 27 digit length can be executed simultaneously. In other words, the shifter circuit according to embodiments of the present invention not only can reduce circuit area, but also can reduce computation time.

The above-described embodiments of the present invention are intended to be illustrative only. Those skilled in the art may devise numerous alternative embodiments without departing from the scope of the following claims.

What is claimed is:

1. A method for decomposing an N-digit barrel shifter into a plurality of barrel shifters with fewer digits, the method comprising the steps of:
decomposing N as a product of integers ranging from N₁ to Nₘ, wherein the integers ranging from N₁ to Nₘ are not equal to 1;
constructing (N/Nₖ) Nₖ-digit barrel shifters to form a shifter circuit layer with m layers, wherein k is equal to an integer between 1 to m; and
coupling output terminals of the barrel shifters in a r^{th} layer to input terminals of the barrel shifters in a (r+1)^{th} layer, wherein r is an integer between 1 to m−1.

2. The method of claim 1, wherein the coupling step is to couple output terminals of an i^{th} barrel shifter in the r^{th} layer to a b^{th} input terminal of an a^{th} barrel shifter in the (r+1)^{th} layer, wherein
a is equal to
$$floor ( \frac{i - 1}{\frac{N}{{\prod }_{u = 1}^{k} {N}_{u}}} ) \frac{N}{{N}_{k + 1} {\prod }_{u = 1}^{k - 1} {N}_{u}} + \frac{N}{{\prod }_{u = 1}^{k + 1} {N}_{u}} j + mod ( ( i - 1 ) , \frac{N}{{\prod }_{u = 1}^{k + 1} {N}_{u}} ) + 1 ;$$
b is equal to
$$ceiling ( \frac{mod ( ( i - 1 ) , \frac{N}{{\prod }_{u = 1}^{k} {N}_{u}} ) + 1}{\frac{N}{{\prod }_{u = 1}^{k + 1} {N}_{u}}} ) ;$$
j is an integer ranging from to 0 to N₁−1;
mod represents a modulo operation;
floor represents a floor operation; and
ceiling represents a ceiling operation.

3. The method of claim 1, which is utilized in a wireless communication device complying with IEEE 802.11n standard.

4. A shifter circuit comprising (N/Nₖ) Nₖ-digit barrel shifters in a k^{th} layer, wherein k is an integer ranging from 1 to m, N is a product of integers ranging from N₁ to Nₘ, and the integers ranging from N₁ to Nₘ are not equal to 1.

5. The shifter circuit of claim 4, wherein output terminals of an i^{th} barrel shifter in a r^{th} layer is coupled to a b^{th} input terminal of an a^{th} barrel shifter in a (r+1)^{th} layer, wherein r is equal to an integer between 1 to m−1, a is equal to
$$floor ( \frac{i - 1}{\frac{N}{{\prod }_{u = 1}^{k} {N}_{u}}} ) \frac{N}{{N}_{k + 1} {\prod }_{u = 1}^{k - 1} {N}_{u}} + \frac{N}{{\prod }_{u = 1}^{k + 1} {N}_{u}} j + mod ( ( i - 1 ) , \frac{N}{{\prod }_{u = 1}^{k + 1} {N}_{u}} ) + 1 ;$$
b is equal to
$$ceiling ( \frac{mod ( ( i - 1 ) , \frac{N}{{\prod }_{u = 1}^{k} {N}_{u}} ) + 1}{\frac{N}{{\prod }_{u = 1}^{k + 1} {N}_{u}}} ) ;$$
j is an integer ranging from to 0 to N₁−1;
mod represents a modulo operation;
floor represents a floor operation; and
ceiling represents a ceiling operation.

6. The shifter circuit of claim 5, wherein N is equal to 81.

7. The shifter circuit of claim 6, wherein both N₁ and N₂ are equal to 9.

8. The shifter circuit of claim 6, wherein both N₁ and N₂ are equal to 3, and N₃ is equal to 9.

9. The shifter circuit of claim 4, which is utilized in a wireless communication device complying with IEEE 802.11n standard.

10. A method for controlling a shifter circuit of claim 5 to cyclic shift an N-digit input word by S digits, the method comprising the steps of:
calculating a vertical shift value S_{V1} and a horizontal shift value S_{H1} in a 1^{st} shifter circuit layer, wherein S_{V1} is floor(S/(N/N₁)), S_{H1} is mod(S,(N/N₁));
calculating vertical shift values S_{Vk} and horizontal shift values S_{Hk} in a q^{th} shifter circuit layer, wherein S_{Vq} is floor(P/(M/I)), S_{Hq} is mod(P, (M/I)), q is an integer between 2 to m−1, P is a horizontal shift value in a (q−1)^{th} shifter circuit layer S_{H(q-1)}, M is
$${\prod }_{u = q}^{m} {N}_{u}$$
and I is N_{q};
grouping barrel shifters in the q^{th} shifter circuit layer into
$${\prod }_{u = 1}^{q - 1} {N}_{u}$$
groups;
controlling all of the barrel shifters in the 1^{th} shifter circuit layer to cyclic shift S_{V1} digits;
controlling a first S_{Hq} barrel shifters in each group in the q^{th} shifter circuit layer to cyclic shift mod(S_{Vq}+1, I) digits, and remaining barrel shifters in the q^{th} shifter circuit layer to cyclic shift S_{Vq} digits; and
controlling all of the barrel shifters in a m^{th} shifter circuit layer to cyclic shift S_{H(m-1)} digits.

11. The method of claim 10, which is utilized in a wireless communication device complying with IEEE 802.11n standard.
